(19) United States
(12) Patent Application Publication
(10) Pub. No.: US 2008/0124206 A1
(43) Pub. Date: May 29, 2008

(54) WAFER TRANSFER APPARATUS

(75) Inventors: Yong Won CHOI, Yongin-si (KR); Juno Park, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/744,324

(22) Filed: May 4, 2007

(30) Foreign Application Priority Data
Nov. 29, 2006 (KR) 2006-119245

(51) Int. Cl. B25J 18/00; G06F 19/00

(52) U.S. Cl. 414/744.2; 700/121

(57) ABSTRACT

A wafer transfer apparatus capable of improving working efficiency by simultaneously and selectively transferring a desired amount of wafers to shorten a wafer transfer time. The wafer transfer apparatus includes a plurality of wafer support members capable of supporting and transferring at least one wafer. The wafer transfer apparatus also includes a moving device connected to the wafer support members so as to move the wafer support members corresponding to a number of wafers to be transferred in such a manner that the wafer support members simultaneously transfer at least one wafer.

### CROSS-REFERENCE TO RELATED APPLICATIONS

This application claims priority under 35 U.S.C. §119(a) from Korean Patent Application No. 2006-119245, filed on Nov. 29, 2006, in the Korean Intellectual Property Office, the disclosure of which is incorporated herein in its entirety by reference.

### BACKGROUND OF THE INVENTION

1. Field of the Invention

The present general inventive concept relates to a wafer transfer apparatus, and more particularly, to a wafer transfer apparatus capable of improving working efficiency by simultaneously and selectively transferring a desired number of wafers to shorten a wafer transfer time.

2. Description of the Related Art

In general, photolithography, etching, ashing, diffusion, chemical vapor deposition, ion implantation, and metal deposition processes are selectively and repeatedly performed on a wafer to form at least one of a conductor layer, a semiconductor layer and a non-conductor layer on the wafer, thereby forming a semiconductor device.

When manufacturing the semiconductor device, the wafer is transferred to a predetermined position according to required processes.

In such a wafer transfer process, a plurality of wafers, which are subject to the same processes, are generally housed in a cassette and are transferred to each process stage. A wafer transfer apparatus is provided in each process stage in order to transfer the wafers to each process position by withdrawing the wafers from the cassette.

Further, in an EDS (electrical die sorting) process to inspect an electrical characteristic of the semiconductor device manufactured through the above process, such a wafer transfer apparatus, is used.

An EDS line is equipped with a plurality of inspection apparatuses. The wafer inspection time of the inspection apparatuses varies. That is, an inspection apparatus A may require a longer time than that of an inspection apparatus B when inspecting the wafer. Accordingly, the wafer loaded in the inspection apparatus B must stay loaded until the inspection of the wafer loaded in the inspection apparatus A has been finished.

Accordingly, efficiency and productivity of the EDS line can be improved by transferring a greater number of wafers to the inspection apparatus that requires a short time to inspect the wafer and to transfer a single wafer or a smaller amount of wafers to the inspection apparatus that requires a longer time to inspect the wafer, in such a manner that inspection for wafers can be simultaneously finished in both inspection apparatuses.

However, according to the conventional wafer transfer apparatus, as disclosed in Korean Unexamined Patent Publication No. 10-2005-119711, only one wafer is transferred at a time, so that the above efficiency and productivity may not be satisfied.

### SUMMARY OF THE INVENTION

The present general inventive concept provides a wafer transfer apparatus capable of transferring a single wafer or a plurality of wafers according to a predetermined condition, so that the wafer transfer efficiency can be improved and, for example, wafer inspection can be simultaneously finished in various inspection apparatuses, thereby improving the efficiency of an assembly line.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a wafer transfer apparatus including a plurality of wafer support members each capable of supporting and transferring at least one wafer, and a moving device connected to the plurality of wafer support members so as to move the plurality of wafer support members corresponding to a number of the plurality of wafers to be transferred in such a manner that the plurality of wafer support members simultaneously transfer the at least one wafer.

The wafer transfer apparatus may further include a plurality of supporters including first and second supporters, at least one of the plurality of wafer support members are connected to the first supporter while forming a first group, the other of the plurality of wafer support members are connected to the second supporter while forming a second group; the first supporter and second supporter are connected to the moving device; and the first supporter, the second supporter, the at least one of the plurality of wafer support members connected to the first supporter and the other of the plurality of wafer support members connected to the second supporter are moved in a group unit according to an operation of the moving device.

The moving device may include a first transfer arm and a second transfer arm connected to the first supporter, the first transfer arm and the second transfer arm forming having a double-folding link structure; a third transfer arm and a fourth transfer arm connected to the second supporter, the third transfer arm and the fourth transfer arm forming a double-folding link structure; and a support plate positioned at a lower portion of the first, second, third and fourth transfer arms so as to support the first, second, third and fourth transfer arms.

The wafer transfer apparatus may further include a position control device that is formed at a lower portion of the support plate so as to allow the plurality of wafer support members to rotate in a predetermined direction and control a vertical movement of the plurality of wafer support members.

The plurality of wafer support members may include a first fixing wafer support member fixed to the first supporter, a second fixing wafer support member fixed to the second supporter, and a rotating wafer support member rotatably installed on the second supporter.

The second supporter may be provided with a rotation motor that rotates the rotating wafer support member.

When the rotating wafer support member transfers the at least one wafer, the rotating wafer support member can be aligned in a direction identical to a direction of the second fixing wafer support member and transfers the at least one wafer while supporting the at least one wafer according to an operation of the moving device.

When the second fixing wafer support member transfers the at least one wafer and the rotating wafer support member does not transfer a wafer, the rotating wafer support member can be aligned in a direction different from a direction of the second fixing wafer support member fixed to the second supporter, such that the rotating wafer support member is prevented from interfering with a cassette in which the at least one wafer is stored.

A vacuum absorption section can be provided at a front end portion of the at least one of the plurality of wafer support members so as to support the at least one wafer by absorbing the wafer using a vacuum.

The foregoing and/or other aspects and utilities of the present general inventive concept may also be achieved by providing a wafer transfer apparatus including a plurality of wafer support members to transfer at least one wafer while supporting the at least one wafer by using a vacuum, a plurality of supporters allowing the plurality of wafer support members to be divided into a plurality of groups and supporting the plurality of wafer support members belonging to each of the plurality of groups such that the plurality of wafer support members are able to move in a group unit, and a moving device connected to the plurality of supporters to selectively move the plurality of wafer support members corresponding to a predetermined number of wafers to be transferred, and to allow the plurality of wafer support members to simultaneously transfer the predetermined number of wafers.

The plurality of supporters may include a first supporter and a second supporter, the first supporter being provided with a first fixing wafer support member coupled with the first supporter, and the second supporter being provided with a second fixing wafer support member coupled with the second supporter and a rotating wafer support member rotatably coupled with the second supporter.

The moving device may include a first moving device and a second moving device, the first moving device including a first arm connected to the first supporter so as to cause a horizontal linear movement of the wafer support member, a second arm connected to the first arm so as to form a link structure together with the first arm, a third arm connected to the second supporter, a fourth arm connected to the third arm so as to form a link structure together with the third arm, and a support plate which is provided at a lower portion of the second arm and the fourth arm so as to allow the second arm and the fourth arm to be stably loaded on the support plate, and the second moving device may include a supporting shaft provided at a lower portion of the support plate, and a position control device connected to the supporting shaft so as to control rotational and vertical movement of the support plate to cause rotational and vertical movement of the wafer support member.

The second supporter may be provided with a rotation motor to rotate the rotating wafer support member.

When the second fixing wafer support member exclusively transfers the at least one wafer, the rotating wafer support member can be aligned in a direction different from a direction of the second fixing wafer support member such that the rotating wafer support member does not interfere with the at least one wafer and a cassette in which the at least one wafer is stored.

The first fixing wafer support member can be connected to the first supporter, the second fixing wafer support member can be connected to the second supporter, and the rotating wafer support member can simultaneously or individually transfer a predetermined amount of wafers to be transferred according to an operation of the moving device.

The first supporter and the second supporter can be aligned in parallel to each other while being spaced apart from each other.

The foregoing and/or other aspects and utilities of the present general inventive concept may also be achieved by providing a wafer transfer apparatus usable with a plurality of wafers, the apparatus including a plurality of wafer support members, each of the plurality of wafer support members being capable of transferring at least one of the plurality of wafers, and a moving device connected to the plurality of wafer support members capable of moving the plurality of wafer support members, wherein the moving device simultaneously moves a first number of the plurality of wafer support members corresponding to a first number of the plurality of wafers to be transferred from a first position to a second position.

The foregoing and/or other aspects and utilities of the present general inventive concept may also be achieved by providing a wafer transfer apparatus usable with a first inspection apparatus and a second inspection apparatus, the wafer transfer apparatus including a first set of wafer support members capable of transferring a first set of wafers, a second set of wafer support members capable of transferring a second set of wafers, a moving device connected to the first set of wafer support members and the second set of wafer support members, the moving device to move at least one of the first set of wafer support members to transfer a first number of the first set of wafers to the first inspection apparatus, the first number corresponding to a first time period for the first inspection apparatus to finish an inspection of the first number of wafers, and the moving device to move at least one of the second set of wafer support members to transfer a second number of the second set of wafers to the second inspection apparatus, the second number corresponding to a second time period for the second inspection apparatus to finish an inspection of the second number of wafers, wherein the inspection of the first number of the first set of wafers by the first inspection apparatus and the inspection of the second number of the second set of wafers by the second inspection apparatus are simultaneously completed.

The foregoing and/or other aspects and utilities of the present general inventive concept may also be achieved by providing a method of transferring a plurality of wafers from a first position to a second position, the method including selecting a first set of a plurality of wafer support members to form a first group corresponding to a number of the plurality of wafers to be transferred from a first position to a second position, selecting a second set of a plurality of wafer support members to form a second group corresponding to the number of the plurality of wafers, and moving at least one of the first group and the second group either individually or simultaneously corresponding to the number of the plurality of wafers.

The foregoing and/or other aspects and utilities of the present general inventive concept may also be achieved by providing a computer readable recording medium containing computer readable codes to perform a method of transferring a plurality of wafers from a first position to a second position, the method including selecting a first set of a plurality of wafer support members to form a first group corresponding to a number of the plurality of wafers to be transferred from a first position to a second position selecting a second set of a plurality of wafer support members to form a second group corresponding to the number of the plurality of wafers and moving at least one of the first group and the second group either individually or simultaneously corresponding to the number of the plurality of wafers.

The foregoing and/or other aspects and utilities of the present general inventive concept may also be achieved by providing a wafer transfer apparatus including a plurality of groups of wafer support members each to support at least one wafer and a moving device corresponding to each of the plurality of groups of wafer support members to move the respective group of wafer support members separately or simultaneously with respect to each other such that any number of the plurality of groups of wafer support members can be moved at a same time or separately.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a front perspective view illustrating a wafer transfer apparatus according to an embodiment of the present general inventive concept;

FIG. 2 is a rear perspective view illustrating a wafer transfer apparatus according to an embodiment of the present general inventive concept;

FIG. 3 is a front view illustrating a wafer transfer apparatus according to an embodiment of the present general inventive concept;

FIG. 4 is a perspective view illustrating a process to transfer a single wafer in an embodiment of the present general inventive concept;

FIG. 5 is a perspective view illustrating a process to transfer two wafers in an embodiment of the present general inventive concept;

FIG. 6 is a perspective view illustrating a process to transfer three wafers in an embodiment of the present general inventive concept;

FIG. 7 is a perspective view illustrating a process to transfer four wafers in an embodiment of the present general inventive concept;

FIG. 8 is a perspective view illustrating a process to transfer seven wafers in an embodiment of the present general inventive concept; and

FIG. 9 is flow chart illustrating a method of transferring a plurality of wafers in an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

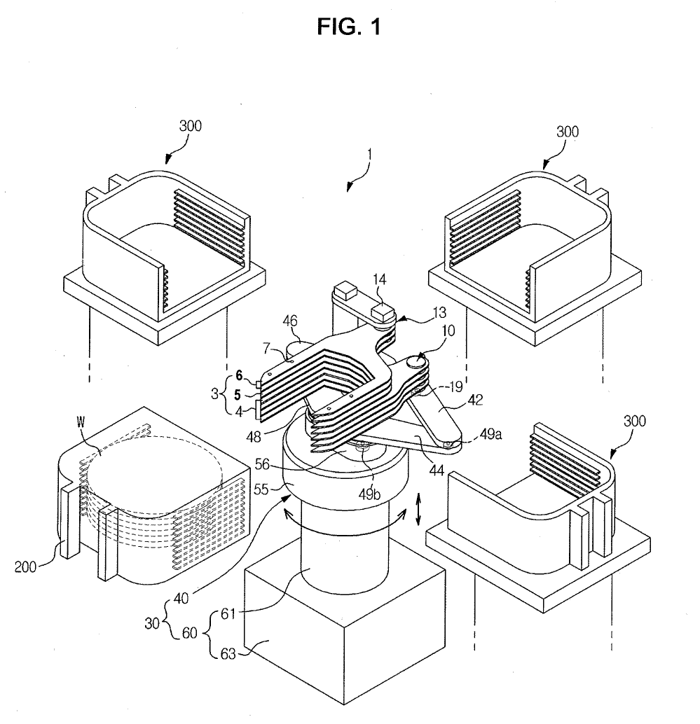

FIG. 1 is a front perspective view illustrating a wafer transfer apparatus according to an embodiment of the present general inventive concept. As illustrated in FIG. 1, a cassette 200 to house a plurality of wafers W and an inspection apparatus 300 to test the wafers W are provided in proximity to a wafer transfer apparatus 1 according to an embodiment of the present general inventive concept.

The wafer transfer apparatus 1, as illustrated in FIG. 1, withdraws the wafer W from the cassette 200, rotates to face an inspection apparatus 300 and then loads the wafer W in the inspection apparatus 300 so that the wafer W is inspected in the inspection apparatus 300.

Although the cassette 200 is positioned at one side of the wafer transfer apparatus 1 and the inspection apparatus 300 is positioned at another side of the wafer transfer apparatus 1, such an arrangement can be changed according to a process condition.

In an embodiment of the present general inventive concept, the wafer transfer apparatus 1, as illustrated in FIG. 1, includes a plurality of wafer support members 3, for example, having a “Y” or “U” shape, first and second supporters 10 and 13, which are connected to a rear portion of the respective wafer support member 3 so as to support the wafer support member 3 connected thereto, and a moving device 30, which is connected to the first and second supporters 10 and 13 to allow the wafer support member 3 to move in a linear direction.

The first and second supporters 10 and 13 can be, for example, arranged in parallel to each other.

In an embodiment of the present general inventive concept, the moving device 30 includes a first moving device 40 and a second moving device 60. As illustrated in FIG. 1, the first moving device 40 includes a first transfer arm 42 connected to, for example, a lower portion of the first supporter 10, a second transfer arm 44 connected to one end of the first transfer arm 42 to form a link structure together with the first transfer arm 42, a third transfer arm 46 connected to, for example, the lower portion of the second supporter 13, a fourth transfer arm 48 connected to the third transfer arm 46 to form a link structure together with the third transfer arm 46, and a support plate 55 to rotatably support the second and fourth transfer arms 44 and 48.

The second moving device 60, for example, includes a supporting shaft 61 provided at a lower portion of the support plate 55, and a position control device 63, which is connected to the supporting shaft 61 to control the rotational and vertical movement of the support plate 55 so as to control the rotational and vertical movement of the wafer support member 3. The structure of the position control device 63 can include conventional position control devices generally known in the art.

In an embodiment of the present general inventive concept, seven wafer support members 3 are provided, in which the seven wafer support members 3 consist of, for example, four first fixing wafer support members 4 fixed to the first supporter 10, one second fixing wafer support member 5 fixed to the second supporter 13, and two rotating wafer support members 6 rotatably provided on the second supporter 13.

Accordingly, the first supporter 10 and the first fixing wafer support member 4 are simultaneously moved while forming a group, and the second supporter 13, the second fixing wafer support member 5 and the rotating wafer support member 6 are simultaneously moved while forming another group, in such a manner that each group can individually or simultaneously move according to the number of the wafers W being transferred.

Although a few embodiments of the present general inventive concept illustrate and describe seven wafer support members 3, it will be appreciated by those skilled in the art that the number of wafer support members 3 may vary depending on a process condition without departing from the principles and spirit of the general inventive concept.

A rotation motor 14, which is connected to and rotates the rotating wafer support members 6, is provided, for example, on the upper portion of the second supporter 13.

The rotation motor 14 controls the rotational direction of the rotating wafer support members 6 according to a transfer operation of the rotating wafer support members 6.

For example, when transferring one wafer, the second fixing wafer support member 5 is inserted into the cassette 200 so as to transfer a wafer W. Accordingly, the rotation motor 14 is driven so as to rotate the rotating wafer support members 6 in a direction different from a direction of the second fixing wafer support member 5 so that the rotating wafer support members 6 are prevented from colliding or interfering with the wafers W loaded in the cassette 200.

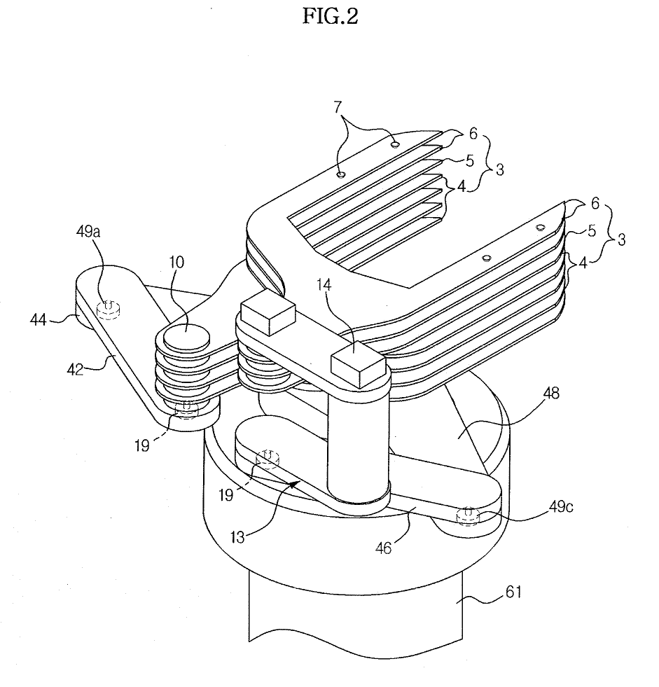

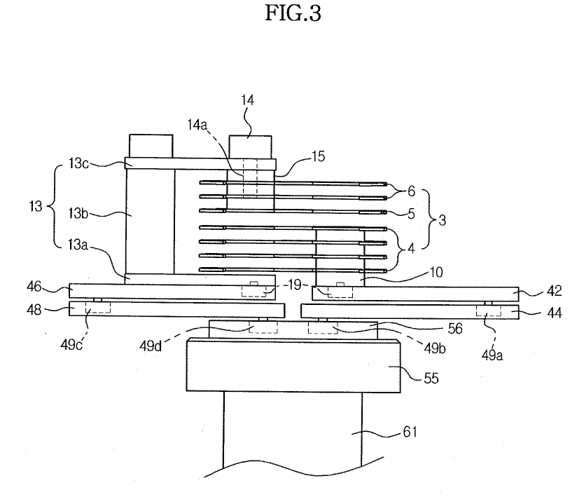

Accordingly, as illustrated in FIGS. 2 and 3, the first, second, third and fourth transfer arms 42, 44, 46 and 48 include first, second, third, and fourth drive motors 49a, 49b, 49c, and 49d, respectively. Each of the first, second, third and fourth transfer arms 42, 44, 46 and 48 is rotated, for example, by operation of first, second, third, and fourth drive motors 49a, 49b, 49c and 49d. Since the first, second, third and fourth transfer arms 42, 44, 46 and 48 form a link structure, the rotational movement of the first, second, third and fourth transfer arms 42, 44, 46, and 48 is converted into linear movement.

In an embodiment of the present general inventive concept, a vacuum absorption section 7 is provided at, for example, an upper front portion of each of the wafer support members 3, as illustrated in FIGS. 1 and 2, so as to fix the wafer W loaded on the wafer support member 3 by using a vacuum.

FIG. 2 is a rear perspective view illustrating a wafer transfer apparatus according to an embodiment of the present general inventive concept. As illustrated in FIG. 2, the first supporter 10 can have a shape of a substantially straight vertical line such as, for example, a shape of “1” and a rear portion of the first fixing wafer support member 4 is fixed to an outer peripheral surface of the first supporter 10. In contrast, the second supporter 13 can have a substantially curved-shape, such as, for example, a shape of “ [symbol] ” and the rotation motor 14 is provided on the second supporter 13.

As described above, the first and third drive motors 49a and 49c are provided at connection portions or areas between the first and second transfer arms 42 and 44 and between the third and fourth transfer arms 46 and 48, respectively. Further, position control members 19 are provided between the first transfer arm 42 and the first supporter 10, and between the third transfer arm 46 and the second supporter 13 in order to maintain in a fixed manner the position of the wafer support member 3 coupled to the first and second supporters 10 and 13 when the first and third transfer arms 42 and 46 are rotated.

FIG. 3 is a front view illustrating a wafer transfer apparatus according to an embodiment of the present general inventive concept. As illustrated in FIG. 3, the second and fourth drive motors 49b and 49d that drive the second and fourth transfer arms 44 and 48 are provided in a protrusion 56 formed on the support plate 55, and the motor shafts of the second drive motor 49b and fourth drive motor 49d are coupled to end portions of the second and fourth transfer arms 44 and 48.

As illustrated in FIG. 3, the first and third drive motor 49a and 49c that drive the first and third transfer arms 42 and 46 are housed in the other end portions of the second and fourth transfer arms 44 and 48, and motor shafts of the second and fourth drive motors 49b and 49d are coupled with end portions of the first and third transfer arms 42 and 46. In addition, the other end portions of the first and third transfer arms 42 and 46 are provided with the position control members 19 which are coupled to the first and second supporters 10 and 13 so as to control the position of the first and second supporters 10 and 13.

In an embodiment of the present general inventive concept, the second supporter 13 having, for example, the “ [symbol] ” shape includes a lower supporter 13a provided on the upper portion of the third transfer arm 46 so as to be coupled with the position control member 19, an upper supporter 13c on which the rotation motor 14 is mounted, and a connection member 13b connecting the lower supporter 13a with the upper supporter 13c. At a lower portion of the upper supporter 13c is a supporting rod 15 that is coupled in a fixed manner with the second fixing wafer support member 5.

Further, a rotating shaft 14a of the rotation motor 14 is provided in the supporting rod 15. The rotating shaft 14a of the rotation motor 14 is coupled with the rotating wafer support member 6 so as to rotate the rotating wafer support member 6.

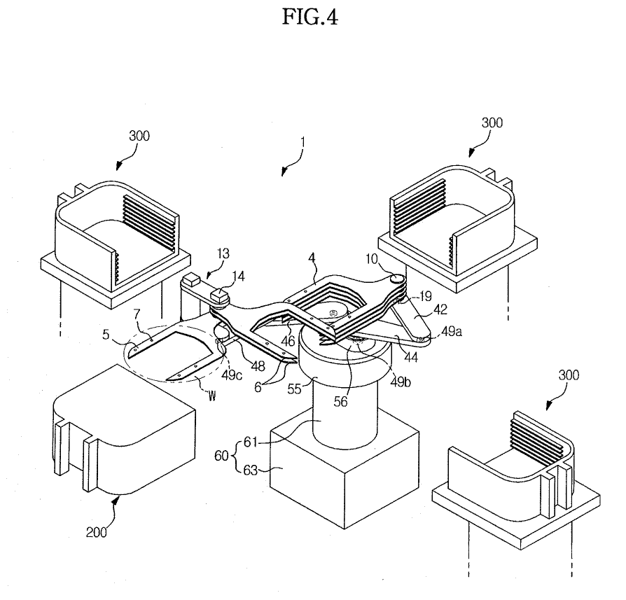

FIG. 4 is a perspective view illustrating a process to transfer a single wafer according to an embodiment of the present general inventive concept. As illustrated in FIG. 4, when the wafer transfer apparatus 1 transfers one wafer W from the cassette 200, only the second fixing wafer support member 5 is used. In this case, the rotating wafer support member 6 rotates by 90 degrees relative to the second fixing wafer support member 5 so that the rotating support member 6 does not interfere with the cassette 200.

Thus, in an orientation in which the second fixing wafer support member 5 faces the wafer W in the cassette 200, the third and fourth drive motors 49c and 49d connected to the third and fourth transfer arms 46 and 48 operate so that the third and fourth transfer arms 46 and 48 extend forward. Accordingly, the second fixing wafer support member 5 is inserted into the cassette 200 and positioned, for example, under the wafer W to be transferred. The wafer W is fixed on the second fixing wafer support member 5 by applying a vacuum to the wafer W using the vacuum absorption section 7.

If the third and fourth transfer arms 46 and 48 are folded again with a wafer W fixed on the second fixing wafer support member 5, the wafer W attached to the second fixing wafer support member 5 is unloaded from the cassette 200 as the second fixing wafer support member 5 is moved back.

In addition, as the support plate 55 is rotated by the position control device 63, the second fixing wafer support member 5 is simultaneously rotated. Thus, the second fixing wafer support member 5 reaches a front portion of the inspection apparatus 300, and then is inserted into the inspection apparatus 300 as the third and fourth transfer arms 46 and 48 are extended.

When the wafer W is placed in the inspection apparatus 300, the vacuum state of the vacuum absorption section 7 is released so that the second fixing wafer support member 5 is separated from the wafer W. As the third and fourth transfer arms 46 and 48 are folded backwards, the second fixing wafer support member 5 moves back while leaving the wafer W in the inspection apparatus 300. The above procedure can be continuously repeated.

Accordingly, since the first and second transfer arms 42 and 44 are kept in a folded state, the first fixing wafer support member 4 remains in an original withdrawn state.

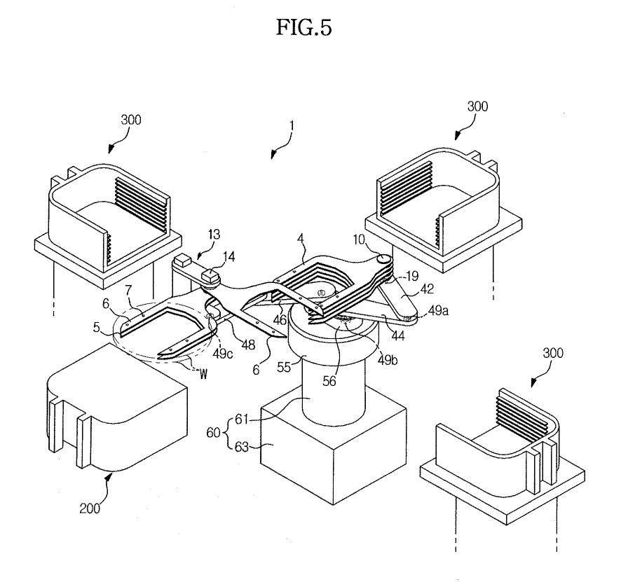

FIG. 5 is a view illustrating a process to transfer two wafers W at a time in an embodiment of the present general inventive concept. As illustrated in FIG. 5, one of the rotating wafer support members 6 is aligned in the same direction with the second fixing wafer support member 5, and the other is maintained in a fixed manner while being rotated by 90 degrees relative to the second fixing wafer support member 5.

Accordingly, the second fixing wafer support member 5 and one of the rotating wafer support member 6 enter the cassette 200 so as to transfer two wafers W to the inspection apparatus 300. In an embodiment of the present general inventive concept, the transfer mechanism for two wafers W, for example, may be similar to the transfer mechanism for one wafer W.

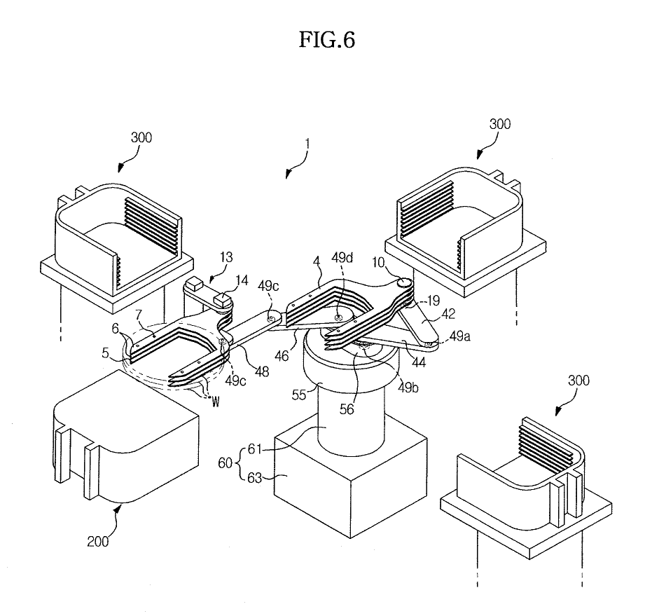

FIG. 6 is a view illustrating a process to transfer three wafers W at a time in an embodiment of the present general inventive concept. As illustrated in FIG. 6, the second fixing wafer support member 5 and the rotating wafer support member 6 are aligned in the same direction, and three wafers are simultaneously transferred to the inspection apparatus 300 by the extending and folding operation of the third and fourth transfer arms 46 and 48.

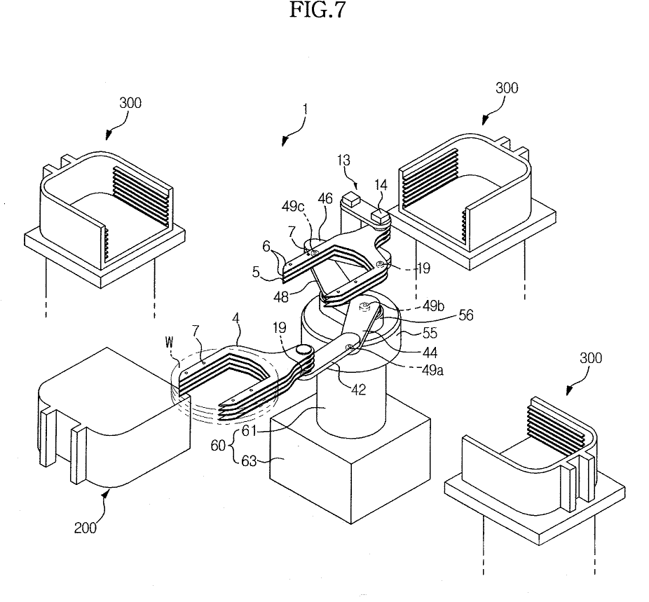

FIG. 7 is a view illustrating a process to transfer four wafers W at a time in an embodiment of the present general inventive concept. As illustrated in FIG. 7, the third and fourth transfer arms 46 and 48 are withdrawn and folded so that the second fixing wafer support member 5 and the rotating wafer support member 6 are keep in a withdrawn state.

Accordingly, the first and second arms 42 and 44 extend toward the cassette 200, so that four first fixing wafer support members 4 are inserted into the cassette 200, and pick up the wafers W using the vacuum absorption section. After picking up the wafers W, the four first fixing wafer support members 4 are rotatably moved toward the inspection apparatus 300 by the position control device 63, so that four wafers W are loaded into the inspection apparatus 300 at a time.

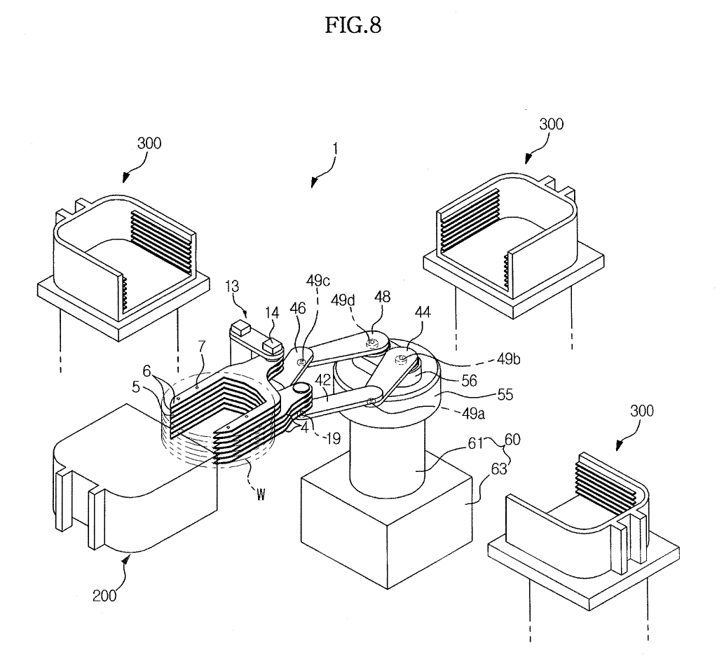

FIG. 8 is a view illustrating a process of transferring seven wafers W at a time in an embodiment of the present general inventive concept. As FIG. 8 illustrates, seven wafers W are simultaneously transferred by the first and second fixing wafer support members 4 and 5 and the rotating wafer support member 6.

Accordingly, the first and second transfer arms 42 and 44 and the third and fourth transfer arms 46 and 48 simultaneously extend toward the cassette 200, so that the second fixing wafer support member 5 and the rotating wafer support member 6 are placed over the first fixing wafer support member 4. The first and second transfer arms 42 and 44 enter the cassette 200, thereby transferring seven wafers W to the inspection apparatus 300.

Although not illustrated in the figures, the process of transferring five wafers W can be achieved by combining, for example, a one-wafer transfer mechanism, as illustrated in FIG. 4, with a four-wafer transfer mechanism, as illustrated in FIG. 7. In addition, the process of transferring six wafers W can be achieved by combining a two-wafer transfer mechanism, as illustrated in FIG. 5, with a four-wafer transfer mechanism, as illustrated in claim 7. Accordingly, the first to fourth transfer arms 42 to 48 simultaneously perform the extending and folding operation.

Accordingly, one to seven wafers can be selectively transferred to the inspection apparatus 300 by properly aligning the first and second fixing wafer transfer members 4 and 5 and the rotating wafer transfer member 6.

Therefore, the transfer mechanism for one or two wafers W, as illustrated in FIG. 4 or FIG. 5, is applied to an inspection apparatus that requires a relatively longer time to inspect one wafer, and the transfer mechanism for seven wafers W, as illustrated in FIG. 7, is applied to an inspection apparatus that requires a relatively short time to inspect one wafer. In this manner, the inspection process for the wafer can be simultaneously finished in various inspection apparatuses.

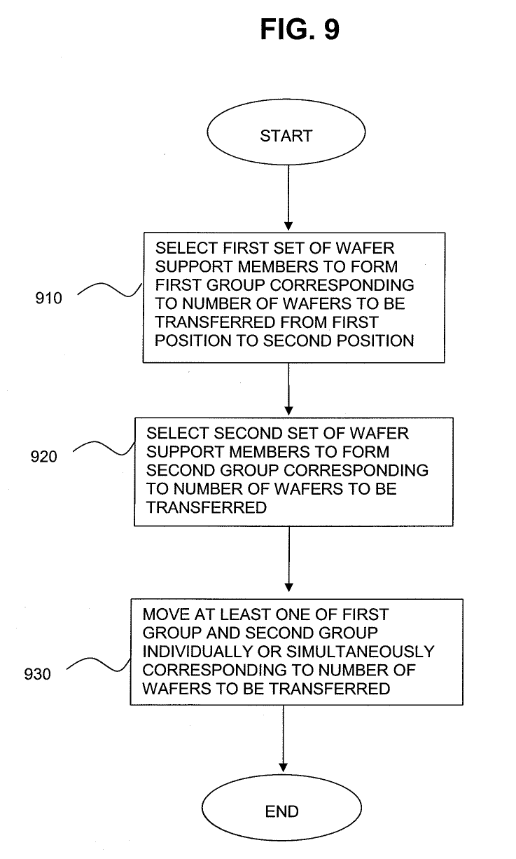

FIG. 9 is flow chart illustrating a method of transferring a plurality of wafers according to an embodiment of the present general inventive concept. As FIG. 9 illustrates, in operation 910, a first set of wafer support members is selected to form a first group of selected wafer support members corresponding to a number of wafers W to be transferred from a first position to a second position.

In operation 920, a second set of wafer support members is selected to form a second group of selected wafer support members corresponding to the number of wafers to be transferred, for example, as identified in operation 910.

In operation 930, at least one of the first group of selected wafer support members and the second group of selected wafer support members is moved either individually or simultaneously corresponding to, for example, the number of wafers to be transferred from the first position to the second position.

To illustrate an example of the embodiment of FIG. 9, reference will be made to FIG. 8. In operation 910, for example, the number of wafers W to be moved as illustrated in FIG. 8 is seven. Thus, in referring to FIG. 8 for purposes of this example, the first group of wafer support members selected can be the four first fixing wafer support members 4. Also, the first position can be, for example, a position of a cassette 200 to store wafers and the second position can be, for example, a position of an inspection apparatus 300. In referring to FIG. 8 for purposes of this example, in operation 920, the second group of wafer support members selected can be the two rotating wafer support members 6 and the second fixing wafer support member 5. Thus, the second group formed in operation 920, for example, will be transferring three of the seven wafers and the first group formed in operation 910 will be transferring four of the seven wafers W. In operation 930, both the first group and the second group are moved simultaneously to transfer the seven wafers from the cassette 200 to, for example, the inspection apparatus 300.

Although the wafer transfer apparatus of the present general inventive concept has been described as it is applied to the inspection line, the present general inventive concept is not limited thereto, but can be applied to various processes requiring the wafer transfer mechanism.

As described above, according to the present general inventive concept, a plurality of wafers can be selectively transferred to the inspection apparatus according to a process condition, so that the wafer transfer time can be significantly shortened when compared with that of the wafer transfer mechanism used to transfer only one wafer and, thus, improving the transfer efficiency of the wafer.

The present general inventive concept can also be embodied as computer-readable codes on a computer-readable recording medium. The computer-readable recording medium is any data storage device that can store data which can be thereafter read by a computer system. Examples of the computer-readable recording media include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments to accomplish the present general inventive concept can be easily construed by programmers skilled in the art to which the present general inventive concept pertains.

In addition, the inspection process for the wafer can be simultaneously finished in various inspection apparatuses by properly establishing the wafer transfer mechanism in the inspection apparatuses, so that the efficiency of the inspection line can be improved.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A wafer transfer apparatus comprising:
a plurality of wafer support members each capable of supporting and transferring at least one wafer; and
a moving device connected to the plurality of wafer support members to move the plurality of wafer support members corresponding to a number of wafers to be transferred in such a manner that the plurality of wafer support members simultaneously transfer the at least one wafer.

2. The wafer transfer apparatus as set forth in claim 1, further comprising:
a plurality of supporters including first and second supporters;
at least one of the plurality of wafer support members are connected to the first supporter while forming a first group;
the other of the plurality of wafer support members are connected to the second supporter while forming a second group; the first supporter and the second supporter are connected to the moving device; and
the first supporter, the second supporter, the at least one of the plurality of wafer support members connected to the first supporter and the other of the plurality of wafer support members connected to the second supporter are moved in a group unit according to an operation of the moving device.

3. The wafer transfer apparatus as set forth in claim 2, wherein the moving device comprises:
a first transfer arm and a second transfer arm connected to the first supporter, the first transfer arm and the second transfer arm forming a double-folding link structure;
a third transfer arm and a fourth transfer arm connected to the second supporter, the third transfer arm and the fourth transfer arm forming a double-folding link structure; and
a support plate positioned at a lower portion of the first, second, third and fourth transfer arms so as to support the first, second, third and fourth transfer arms.

4. The wafer transfer apparatus as set forth in claim 3, further comprising a position control device which is formed at a lower portion of the support plate so as to allow the plurality of wafer support members to rotate in a predetermined direction and control a vertical movement of the plurality of wafer support members.

5. The wafer transfer apparatus as set forth in claim 2, wherein the plurality of wafer support members include:
a first fixing wafer support member fixed to the first supporter;
a second fixing wafer support member fixed to the second supporter; and
a rotating wafer support member rotatably coupled to the second supporter.

6. The wafer transfer apparatus as set forth in claim 5, wherein the second supporter is provided with a rotation motor that rotates the rotating wafer support member.

7. The wafer transfer apparatus as set forth in claim 5, wherein, when the rotating wafer support member transfers the at least one wafer, the rotating wafer support member is aligned in a direction identical to a direction of the second fixing wafer support member and transfers the at least one wafer while supporting the at least one wafer according to an operation of the moving device.

8. The wafer transfer apparatus as set forth in claim 5, wherein, when the second fixing wafer support member transfers the at least one wafer and the rotating wafer support member does not transfer a wafer, the rotating wafer support member is aligned in a direction different from a direction of the second fixing wafer support member fixed to the second supporter, such that the rotating wafer support member is prevented from interfering with a cassette in which the at least one wafer is stored.

9. The wafer transfer apparatus as set forth in claim 1, further comprising:
a vacuum absorption section provided at a front end portion of the at least one of the plurality of wafer support members to support the at least one wafer by absorbing the at least one wafer using a vacuum.

10. A wafer transfer apparatus comprising:
a plurality of wafer support members to transfer at least one wafer while supporting the at least one wafer by using a vacuum;
a plurality of supporters allowing the plurality of wafer support members to be divided into a plurality of groups and supporting the plurality of wafer support members belonging to each of the plurality of groups such that the plurality of wafer support members are able to move in a group unit; and
a moving device connected to the plurality of supporters to selectively move the plurality of wafer support members corresponding to a predetermined number of wafers to be transferred, and to allow the plurality of wafer support members to simultaneously transfer the predetermined number of wafers.

11. The wafer transfer apparatus as set forth in claim 10, wherein the plurality of supporters include a first supporter and a second supporter, the first supporter is provided with a first fixing wafer support member coupled with the first supporter, and the second supporter is provided with a second fixing wafer support member coupled with the second supporter and a rotating wafer support member rotatably coupled with the second supporter.

12. The wafer transfer apparatus as set forth in claim 11, wherein the moving device includes a first moving device and a second moving device,
the first moving device including a first arm connected to the first supporter so as to cause a horizontal linear movement of the wafer support member, a second arm connected to the first arm so as to form a link structure together with the first arm, a third arm connected to the second supporter, a fourth arm connected to the third arm so as to form a link structure together with the third arm, and a support plate which is provided at a lower portion of the second arm and the fourth arm so as to allow the second arm and the fourth arm to be stably loaded on the support plate, and
the second moving device includes a supporting shaft provided at a lower portion of the support plate, and a position control device connected to the supporting shaft so as to control rotational and vertical movement of the support plate to cause rotational and vertical movement of the wafer support member.

13. The wafer transfer apparatus as set forth in claim 11, wherein the second supporter is provided with a rotation motor to rotate the rotating wafer support member.

14. The wafer transfer apparatus as set forth in claim 11, wherein, when the second fixing wafer support member exclusively transfers the at least one wafer, the rotating wafer support member is aligned in a direction different from a direction of the second fixing wafer support member such that the rotating wafer support member does not interfere with the at least one wafer and a cassette in which the at least one wafer is stored.

15. The wafer transfer apparatus as set forth in claim 11, wherein the first fixing wafer support member connected to the first supporter, the second fixing wafer support member connected to the second supporter, and the rotating wafer support member simultaneously or individually transfer a predetermined amount of wafers to be transferred according to an operation of the moving device.

16. The wafer transfer apparatus as set forth in claim 11, wherein the first supporter and the second supporter are aligned in parallel to each other while being spaced apart from each other.

17. A wafer transfer apparatus usable with a plurality of wafers, the apparatus comprising:
a plurality of wafer support members each capable of transferring at least one of the plurality of wafers; and
a moving device connected to the plurality of wafer support members capable of moving the plurality of wafer support members;
wherein the moving device can simultaneously move a first number of the plurality of wafer support members corresponding to a first number of the plurality of wafers to be transferred from a first position to a second position.

18. The wafer transfer apparatus according to claim 17, wherein the first number of the plurality of wafer support members and the first number of the plurality of wafers are equal.

19. A wafer transfer apparatus usable with a first inspection apparatus and a second inspection apparatus, the wafer transfer apparatus comprising:
a first set of wafer support members capable of transferring a first set of wafers;
a second set of wafer support members capable of transferring a second set of wafers;
a moving device connected to the first set of wafer support members and the second set of wafer support members,
the moving device to move at least one of the first set of wafer support members to transfer a first number of the first set of wafers to the first inspection apparatus, the first number corresponding to a first time period for the first inspection apparatus to finish an inspection of the first number of wafers; and
the moving device to move at least one of the second set of wafer support members to transfer a second number of the second set of wafers to the second inspection apparatus, the second number corresponding to a second time period for the
second inspection apparatus to finish an inspection of the second number of wafers;
wherein the inspection of the first number of the first set of wafers by the first inspection apparatus and the inspection of the second number of the second set of wafers by the second inspection apparatus can be simultaneously completed.

20. A method of transferring a plurality of wafers from a first position to a second position, the method comprising:
selecting a first set of a plurality of wafer support members to form a first group corresponding to a number of the plurality of wafers to be transferred from a first position to a second position;
selecting a second set of a plurality of wafer support members to form a second group corresponding to the number of the plurality of wafers; and
moving at least one of the first group and the second group either individually or simultaneously corresponding to the number of the plurality of wafers.

21. A computer readable recording medium containing computer readable codes to perform a method of transferring a plurality of wafers from a first position to a second position, the method comprising:
selecting a first set of a plurality of wafer support members to form a first group corresponding to a number of the plurality of wafers to be transferred from a first position to a second position;
selecting a second set of a plurality of wafer support members to form a second group corresponding to the number of the plurality of wafers; and
moving at least one of the first group and the second group either individually or simultaneously corresponding to the number of the plurality of wafers.

22. A wafer transfer apparatus, comprising:
a plurality of groups of wafer support members each to support at least one wafer; and
a moving device corresponding to each of the plurality of groups of wafer support members to move the respective group of wafer support members separately or simultaneously with respect to each other such that any number of the plurality of groups of wafer support members can be moved at a same time or separately.

23. The wafer transfer apparatus as set forth in claim 22, wherein each of the plurality of groups of wafer support members supports a different number of wafers with respect to the other ones of the plurality of groups of wafer support members.

24. The wafer transfer apparatus as set forth in claim 22, wherein each of the moving devices comprises:
a group of transfer arm mechanisms which expand and contract with respect to each other to extend and retract the respective plurality of groups of wafer support members to transfer the respective at least one wafer.
